(19) United States
(12) Patent Application Publication
(10) Pub. No.: US 2004/0122755 A1
(43) Pub. Date: Jun. 24, 2004

(54) Method for financing business expenses

(76) Inventors: Ernest A. Bates, Napa, CA (US); Craig Tagawa, Vallejo, CA (US)

Correspondence Address: D. Whitlow Bivens, Musick, Peeler & Garrett, LLP, Suite 1900, 225 Broadway, San Diego, CA, 92101, US

(21) Appl. No.: 10/325,329

(22) Filed: Dec. 19, 2002

(51) Int. Cl. G06F 17/60

(52) U.S. Cl. 705/35

(57) ABSTRACT

A method for financing a business expense comprising a method of tax-exempt financing that may be classified as an operating lease pursuant to Generally Accepted Accounting Principles in the United States of America at the time of the invention.

### BACKGROUND OF THE INVENTION

1. Field of the Invention

The invention relates generally to a method of financing business expenses. More specifically, the invention relates to a method of financing business expenses through tax-exempt leasing. Most specifically, the invention relates to a method of financing business expenses through tax-exempt leasing wherein the lease may be classified as an operating lease pursuant to applicable Generally Accepted Accounting Principles in the United States.

2. Description of Related Art

U.S. Pat. No. 6,405,177 discloses a system for securing commercial transactions conducted on-line. The system involves an insurer guaranteeing that certain aspects of an on-line sale will be as they are represented to be at the point of sale and that any transaction involving a credit card will be secure.

U.S. Pat. No. 6,343,738 discloses sampling, escrowing, and other tools and techniques for facilitating transactions that involve digital goods.

U.S. Pat. No. 6,263,320 discloses a method of financing the acquisition of an automobile and a related data processing system. The preferred method facilitates the purchase of automobiles incorporating modern safety features by third parties for young drivers.

U.S. Pat. No. 6,148,293 discloses a data processing and computing system for creating, servicing and paying loan agreements between a borrower and a lender. A novel form of adjustable rate loan structure also is disclosed.

U.S. Pat. No. 6,026,364 discloses a system and method for replacing self insurance with insurance. A method of predicting the cost of self insurance and comparing that cost with the cost of insurance is disclosed. In addition, the concept of issuing a bond and using the proceeds to purchase insurance is disclosed.

U.S. Pat. No. 5,742,775 discloses a data processing and computing system for creating, servicing and paying loan agreements between a lender and a borrower. A novel form of adjustable rate loan structure also is disclosed.

Pages 1 and 2 of the internet site http://www.leasing4publicsafety.com/leasing2law-defined.htm on Oct. 1, 2002 disclosed a method of financing called tax-exempt lease financing to purchase equipment and facilities for use by law enforcement agencies and other political subdivisions.

Page 1 of the internet site

http://www.cisco.com/warp/public/csc/data_sheets/install_sale.html on Oct. 1, 2002 disclosed a method of financing called a tax exempt lease purchase. The page disclosed a lender financing the purchase of hardware, software and services by a tax-exempt entity in the United States for use by the tax-exempt entity.

Page 1 of the internet site

http://www.cisco.com/warp/public/csc/data_sheets/true_lease.html on Oct. 16, 2002 disclosed a method of financing called a fair market value purchase option lease. The page disclosed a lender financing the purchase of a networking solution and granting a lessee the right to use that networking solution in exchange for payments spread over a period of between 12 and 60 months. At the end of the lease term, the lessee may renew the lease at a fair market rental, purchase the equipment for its fair market value or return the equipment without further obligation.

None of the foregoing prior art, alone or in combination, discloses or suggests the present invention.

### SUMMARY OF THE INVENTION

The invention is a method of financing business expenses. One embodiment of the invention comprises the steps of:

1. A tax-exempt entity borrowing a first sum of money from a lender wherein any interest paid pursuant to said loan is not taxed by the United States Federal Government;

2. Said tax-exempt entity using said first sum of money to purchase one or more assets;

3. Said tax-exempt entity then transferring possession and the right to use and enjoy said one or more assets to a third party for a predetermined period of time in exchange for payment by said third party of a second sum of money;

4. Said predetermined period of time not to exceed 75% of the estimated economic life of said one or more assets;

5. said tax-exempt entity granting said third party the option to purchase title to said one or more assets in exchange for a final sum of money at the conclusion of said predetermined period of time; and

6. Said final sum of money being the greater of (i) the fair market value of the asset at the end of said predetermined period of time and (ii) the amount of money sufficient when combined with said second sum of money to complete repayment of said first sum of money plus interest and any lender charges.

Additional steps may be incorporated into the financing structure and are considered to be within the scope of the invention. For example:

7. If said third party does not exercise said option to purchase title to said one or more assets, said tax-exempt entity has the option to compel a fourth party to purchase title to said one or more assets for the amount of money sufficient to repay said first sum of money plus lender charges; and

8. If said tax-exempt entity does not exercise said option to compel said fourth party to purchase said title, said tax-exempt entity retains title and must pay the amount of money sufficient to repay said first sum of money plus lender charges to said lender.

Step 7 allows the tax-exempt entity to avoid many of the risks, such as obsolescence, that may be associated with ownership of said one or more assets.

Said lender charges may include interest charges, financing charges, and any other charges charged by the lender. Said second sum of money may be paid over time or may be paid in one lump sum. In either case, payments from said third party to said tax-exempt entity preferably are equal to or greater than any payments due from said tax-exempt entity to said lender. Further, said payments from said third party preferably are paid to said tax-exempt entity before said tax-exempt entity is required to make a corresponding payment to said lender. Thus, said payments from said third party to said tax-exempt entity are scheduled and sized whereby said tax-exempt entity need not “come out of pocket” to make any payments to said lender.

Said lender may be one or more entities and said loan may be pursuant to the issuance of municipal or other government bonds. Said tax-exempt entity may be any entity or organization that is capable of borrowing a principal amount of money and repaying that principal with interest wherein that interest is not taxed as income by the Federal Government of the United States of America. Said third party may be any tax-exempt entity, any non-tax exempt entity doing work or a project that qualifies for tax-exempt financing, or any other entity that qualifies for tax-exempt financing.

If more than one asset is financed pursuant to the above method, the above method may be applied to each asset individually or the assets may be grouped together and treated collectively.

The above method may be arranged and coordinated by any party including the lender, the tax-exempt entity, the third party, the fourth party, or any other person or entity. The person or entity who arranges and coordinates the above method may charge a fee for such efforts.

### DETAILED DESCRIPTION OF PREFERRED EMBODIMENTS

The following description is made for the purpose of illustrating one or more features of the preferred embodiments of the invention and should not be taken in a limiting sense. The preferred embodiments of the invention are disclosed throughout the present application and its incorporations.

One preferred structure of the invention is as follows:

1. A lender lending a first sum of money to a tax-exempt entity pursuant to the issuance of tax-exempt bonds wherein any interest paid pursuant to the bonds is not taxed by the United States Government;

2. Said tax-exempt entity using said first sum of money to purchase one or more pieces of equipment;

3. Said tax-exempt entity then leasing said one or more pieces of equipment to a third party for a predetermined period of time in exchange for periodic rental payments by said third party;

4. Said predetermined period of time not to exceed 75% of the estimated economic life of the equipment;

5. At the conclusion of said predetermined period of time, said third party having the option to purchase title to said equipment in exchange for a final sum of money;

6. Said final sum of money being the greater of (i) the fair market value of the asset at the end of said predetermined period of time and (ii) the amount of money sufficient to repay said first sum of money plus lender charges thereby retiring the bonds;

7. If said third party does not exercise said option to purchase title to said equipment, said tax-exempt entity has the option to compel a fourth party to purchase title to said one or more assets for the amount of money sufficient to repay said first sum of money plus lender charges thereby retiring the bonds; and

8. If said tax-exempt entity does not exercise said option to compel said fourth party to purchase said title, said tax-exempt entity retains title and must pay the amount of money sufficient to repay said first sum of money plus lender charges thereby retiring the bonds to said lender.

The preferred embodiment of the invention disclosed above allows said third party to classify the right to possession, use and enjoyment of said one or more assets as an operating lease pursuant to Generally Accepted Accounting Principles in the United States at the time of the invention.

The bonds may be issued pursuant to a trust agreement by and between the tax-exempt entity and a bank trustee. The bonds may be limited obligations of the tax-exempt entity, payable solely from said rental payments paid by said third party pursuant to the lease, together with the final purchase price. Debt service on the bonds may be secured by a letter of credit or similar instrument if necessary. The bonds may bear a fixed or variable interest rate. The nominal term of the bonds may be longer than the term of the lease, but the rental payments under the lease together with the final payment paid by either said third party, said fourth party or said tax-exempt entity preferably is sufficient to fully repay the principal and interest on the bonds.

Preferably, rental payments under the lease paid by said third party to said tax-exempt entity are equal to or greater than the debt service due from said tax-exempt entity pursuant to the bonds. Further, said rental payments from said third party preferably are paid to said tax-exempt entity before said tax-exempt entity is required to make a corresponding payment pursuant to the bonds. Thus, said payments from said third party to said tax-exempt entity are scheduled and sized whereby said tax-exempt entity need not “come out of pocket” to make any payments to said lender. In addition, payment of the third or fourth sum of money preferably is required before said tax-exempt entity is required to make any final payment on the bonds.

The fourth party who may be compelled to purchase the equipment at the conclusion of the lease may act as a purchasing agent for the tax-exempt entity and enter into purchase contracts with the vendors of the equipment. The fourth party then may assign its rights under the purchasing contracts to the tax-exempt entity. The tax-exempt entity then may assign any warranty rights as against the vendors of the equipment to the third party who leases the equipment.

The third party who leases the equipment may be unconditionally obligated to pay the rental payments under the lease. If, however, the third party is a government entity in California, the obligation to pay rent may be abated in the event the third party does not have beneficial use of the equipment. The third party may be responsible for maintaining insurance on the equipment. In the event of destruction of the equipment, the insurance proceeds may be applied to repay the bonds. The obligation to maintain insurance may be assigned.

1. A method of financing a business expense comprising:
a tax-exempt entity borrowing a first sum of money from a lender wherein any interest paid pursuant to said loan is not taxed by the United States Federal Government;
said tax-exempt entity using said first sum of money to purchase one or more assets;
said tax-exempt entity then transferring possession and the right to use and enjoy said one or more assets to a third party for a predetermined period of time in exchange for payment by said third party of a second sum of money;
said predetermined period of time not to exceed 75% of the estimated economic life of said one or more assets;
said tax-exempt entity granting said third party the option to purchase title to said one or more assets in exchange for a final sum of money at the conclusion of said predetermined period of time; and
said final sum of money being the greater of (i) the fair market value of the asset at the end of said predetermined period of time and (ii) the amount of money sufficient when combined with said second sum of money to complete repayment of said first sum of money plus interest and any lender charges.

2. The method of financing a business expense of claim 1 wherein if said third party does not exercise said option to purchase title to said one or more assets, said tax-exempt entity having the option to compel a fourth party to purchase title to said one or more assets for the amount of money sufficient when combined with said second sum of money to repay said first sum of money plus lender charges; and
if said tax-exempt entity does not exercise said option to compel said fourth party to purchase said title, said tax-exempt entity retains title and must pay the amount of money sufficient when combined with said second sum of money to repay said first sum of money plus lender charges to said lender.

3. The method of financing a business expense of claim 1 wherein said second sum of money is paid in multiple payments spread over time.

4. The method of financing a business expense of claim 2 wherein said second sum of money is paid in multiple payments spread over time.

5. A method of financing equipment for an operating business comprising:
a tax exempt entity borrowing a first sum of money from a lender pursuant to the issuance of tax-exempt bonds wherein any interest paid pursuant to the bonds is not taxed by the United States Government;
said tax-exempt entity using said first sum of money to purchase one or more pieces of equipment;
said tax-exempt entity then leasing said one or more pieces of equipment to a third party for a predetermined period of time in exchange for periodic rental payments by said third party;
said predetermined period of time not to exceed 75% of the estimated economic life of said one ore more pieces of equipment;
said tax-exempt entity granting said third party the option to purchase title to said one or more pieces of equipment in exchange for a final sum of money at the conclusion of said predetermined period of time; and
said final sum of money being the greater of (i) the fair market value of said one or more pieces of equipment at the end of said predetermined period of time and (ii) the amount of money sufficient to repay said first sum of money plus lender charges thereby retiring the bonds.

6. The method of financing a business expense of claim 5 further comprising:
said tax-exempt entity having the option to compel a fourth party to purchase title to said one or more pieces of equipment for the amount of money sufficient to repay said first sum of money plus lender charges thereby retiring the bonds if said third party does not purchase said one or more pieces of equipment; and
if said tax-exempt entity does not exercise said option to compel said fourth party to purchase said title, said tax-exempt entity retains title and must pay the amount of money sufficient to repay said first sum of money plus lender charges thereby retiring the bonds to said lender.

7. The method of financing a business expense of claim 5 wherein said second sum of money is paid in multiple payments spread over time.

8. The method of financing a business expense of claim 6 wherein said second sum of money is paid in multiple payments spread over time.

9. The method of financing a business expense of claim 1 wherein said third party qualifies for tax-exempt financing.

10. The method of financing a business expense of claim 1 wherein said third party is a tax-exempt entity.

11. The method of financing a business expense of claim 1 wherein said third party is not a tax-exempt entity but is using said one or more assets for a project that qualifies for tax-exempt financing.

12. The method of financing a business expense of claim 5 wherein said third party qualifies for tax-exempt financing.

13. The method of financing a business expense of claim 5 wherein said third party is a tax-exempt entity.

14. The method of financing a business expense of claim 5 wherein said third party is not a tax-exempt entity but is using said one or more assets for a project that qualifies for tax-exempt financing.

15. The method of financing a business expense of claim 2 wherein said method is arranged by said fourth party.

16. The method of financing a business expense of claim 6 wherein said method is arranged by said fourth party.

17. A method of financing a business expense comprising:
a first entity borrowing a first sum of money from a lender;
said first entity using at least some of said first sum of money for purchasing one or more assets;
said first entity leasing at least one of said one or more assets to a second entity;
any interest paid by said first entity to said lender not being taxed by a United States Federal Government; and
said lease having the characteristics of an operating lease as defined by Generally Accepted Accounting Practices in the United States of America.
